(19) United States
(12) Patent Application Publication
(10) Pub. No.: US 2018/0173078 A1
(43) Pub. Date: Jun. 21, 2018

(54) VARIABLE FOCUS CAMERA LENS

(71) Applicant: LENSVECTOR INC., San Jose, CA (US)

(72) Inventor: Peter CLARK, Boxborough, MA (US)

(21) Appl. No.: 15/736,470

(22) PCT Filed: Jun. 15, 2016
(86) PCT No.: PCT/CA2016/050690

§ 371 Date: Dec. 14, 2017

Related U.S. Application Data
(60) Provisional application No. 62/181,496, filed on Jun. 18, 2015.

(51) Int. Cl. G02F 1/29; G03B 13/36

(52) U.S. Cl. CPC G02F 1/29; G02F 2001/294; G03B 13/36

(57) ABSTRACT

An autofocus camera assembly is described. The camera assembly includes an electrically controllable optical power lens and a lens assembly having a frame supporting at least one lens element near the electrically controllable optical power lens. The electrically controllable optical power lens is mounted to an object end of the frame. An aperture stop is provided located either at or within the electrically controllable optical power lens or on an external surface of the frame next to the electrically controllable optical power lens. The aperture stop can include an opaque mask and optionally alignment marks.

### RELATED APPLICATIONS

This application is a regular international filing of, and claims priority from, U.S. Provisional Patent Application No. 62/181,496 filed 18 Jun. 2015, the entirety of which is incorporated herein by reference.

### TECHNICAL FIELD

This application relates to variable focus camera lens assemblies, and in particular camera lens assemblies using an electrically variable “refractive” lens, such as liquid lenses, lenses with deformable polymers, liquid crystal lenses and the like that do not move in physical position to change their focusing characteristics.

### BACKGROUND

Today's auto focus camera market is dominated by voice-coil motor mechanisms that are adapted to physically move the entire base lens along the optical axis of the camera to perform the focus adjustment. The focus tuning range using such technology is defined by the maximal distance of movement.

Alternative motion-less approaches have been proposed based on electrically variable “refractive” lenses, such as liquid lenses, lenses with deformable polymers, liquid crystal lenses, etc.

The design of such electrically variable lenses is limited by their range of tunable optical power, which, in some cases, has a dependence upon the diameter of the lens. For example, this dependence can be an inverse quadratic in the case of liquid crystal lenses. In one specific example, smaller diameters would provide higher optical powers. In addition, the larger is the required diameter, generally the worse is the performance of such lenses (for example, aberrations and MTF degradation, slower response time, more light scattering, etc.).

### SUMMARY

Applicant has discovered that a camera lens assembly can be arranged with its aperture stop in front of the lens assembly so that an electrically variable lens can be placed next to, or at, the aperture stop. This means that the closer the position of that variable lens is to the aperture stop of the camera, the better the overall performance is. With such an electrically variable lens at the aperture stop, the size of the variable lens can be reduced for the same aperture. This provides an improvement in the overall performance of the variable focus camera lens system, and consequently an improvement in the corresponding auto-focus camera.

In accordance with an aspect of the proposed solution there is provided an autofocus camera assembly comprising: an electrically controllable optical power lens; a lens assembly having a frame supporting at least one lens element near said electrically controllable optical power lens, said electrically controllable optical power lens being mounted to an object end of said frame; and an aperture stop located either at or within said electrically controllable optical power lens or on an external surface of said frame next to said electrically controllable optical power lens.

In accordance with another aspect of the proposed solution there is provided a tunable liquid crystal lens comprising at least two liquid crystal cells each modulating a focus of one linear polarization of light and an aperture stop opaque mask inset within a limit of a clear aperture defined by electrodes of said cells.

In accordance with another aspect of the proposed solution there is provided alignment marks registered with respect to said aperture stop.

### BRIEF DESCRIPTION OF THE DRAWINGS

The proposed solution will be better understood by way of the following detailed description of embodiments with reference to the appended drawings, in which:

FIG. 1 is a schematic diagram of a conventional small aperture fixed focus camera having an aperture stop located at an outer periphery of an external convex lens with a Tunable Liquid Crystal Lens (TLCL) located in front of the external lens at a distance ‘d’ from the aperture stop;

FIG. 2 is a schematic diagram illustrating in cross-section a portion of a base lens frame, external lens and TLCL according to FIG. 1;

FIG. 3 is a plot of Modulation Transfer Function (MTF) approximation as a function of fractional field (to corner) for the camera lens arrangement of FIGS. 1 and 2, in which MTF performance is shown for center to top right (TR), bottom right (BR), bottom left (BL) and top left (TL);

FIG. 4A is a schematic diagram of a TLCL structure having an aperture stop layer provided within the TLCL layered geometry at the front of a lens assembly for an autofocus camera in accordance with one embodiment of the proposed solution;

FIG. 4B is a simplified schematic diagram of an optical arrangement illustrated in FIG. 4A showing light rays and omitting details of the base lens in accordance with the embodiment of the proposed solution;

FIG. 5A is a schematic diagram of a TLCL structure having an aperture stop within the TLCL abutting a base lens frame similar to the arrangement shown in FIGS. 4A and 4B in accordance with another embodiment of the proposed solution;

FIG. 5B is a schematic diagram of a TLCL structure having an aperture stop on an exterior surface of a TLCL abutting a base lens frame similar to the arrangement shown in FIGS. 4A and 4B in accordance with a further embodiment of the proposed solution;

FIG. 5C is a schematic diagram a TLCL structure abutting a base lens frame similar to the arrangement shown in FIGS. 4A and 4B with an aperture stop extending from a planar peripheral flange of the base lens frame in accordance with yet another embodiment of the proposed solution;

FIG. 6 is a schematic plot illustrating MTF performance, from center to top right (TR), bottom right (BR), bottom left (BL) and top left (TL) for the camera (lens) geometry of FIGS. 4A, 4B and 5A through 5C in accordance with the proposed solution; and

FIG. 7 illustrates a schematic front view of a TLCL according to FIG. 5B in which the aperture mask is printed with alignment indicia to aid in alignment of the TLCL with the base lens frame,

wherein similar features bear similar labels throughout the drawings. While the layer sequence described is of significance, reference to “front” and “back” qualifiers in the present specification is made solely with reference to the orientation of the drawings as presented in the application and do not imply any absolute spatial orientation.

### DETAILED DESCRIPTION

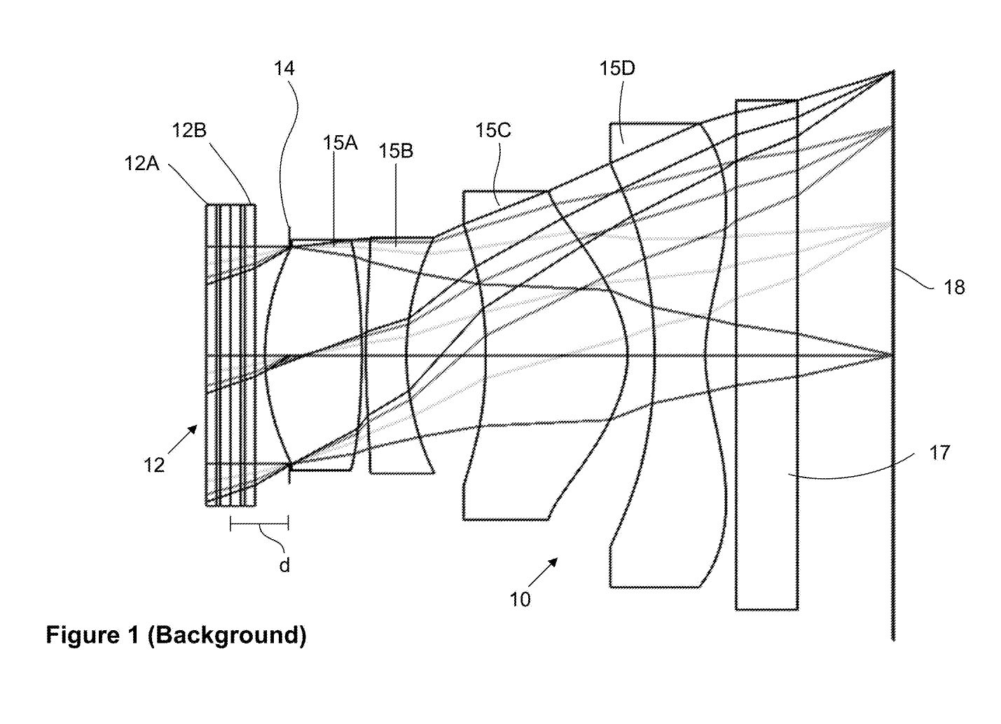

As illustrated in FIG. 1, a conventional autofocus camera 10 can have a fixed focus series of lenses 15A to 15D and a filter 17 with the objective to form a far field image at image sensor 18 from light entering through aperture stop 14. The ability to focus a near field image requires more optical power that is variably provided by an electrically variable lens 12. The lens 12 can be a tunable liquid crystal lens having two liquid crystal cells 12A and 12B each focussing light in one (of two orthogonal) linear polarization. Such liquid crystal lenses are known in the art.

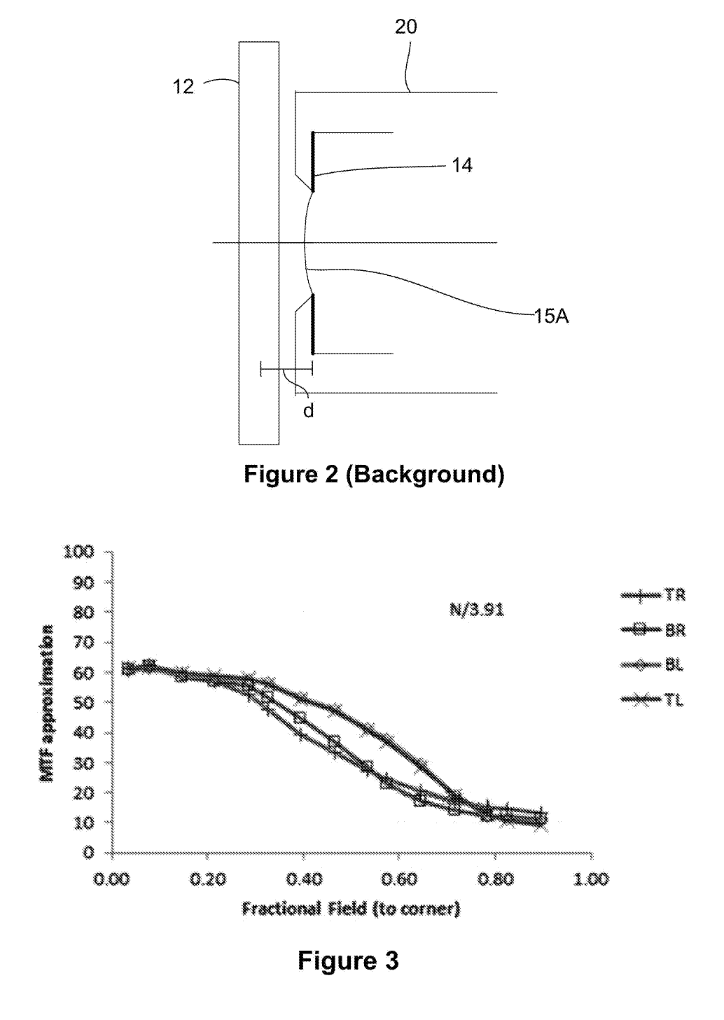

As more schematically illustrated in FIG. 2, a lens assembly can have a frame or barrel 20 with a stop 14 built into the end of the barrel that holds the external lens 15A. A TLCL or other electrically tunable lens 12 can be mounted to the end of the barrel 20. This puts the stop 14 at about 400 microns from the tunable lens 12. The clear aperture of the lens 15A can be about 2.19 mm.

As illustrated in FIG. 3, the arrangement of FIG. 2 provides an approximate Modulation Transfer Function (MTF) in percent versus fractional field to the corner for four corner directions center to top right (TR), bottom right (BR), bottom left (BL) and top left (TL). As can be appreciated (seen), with the TLCL 12 sized larger than the aperture stop 14, the MTF of the TLCL is poor, particularly at fractional field values greater than 0.50.

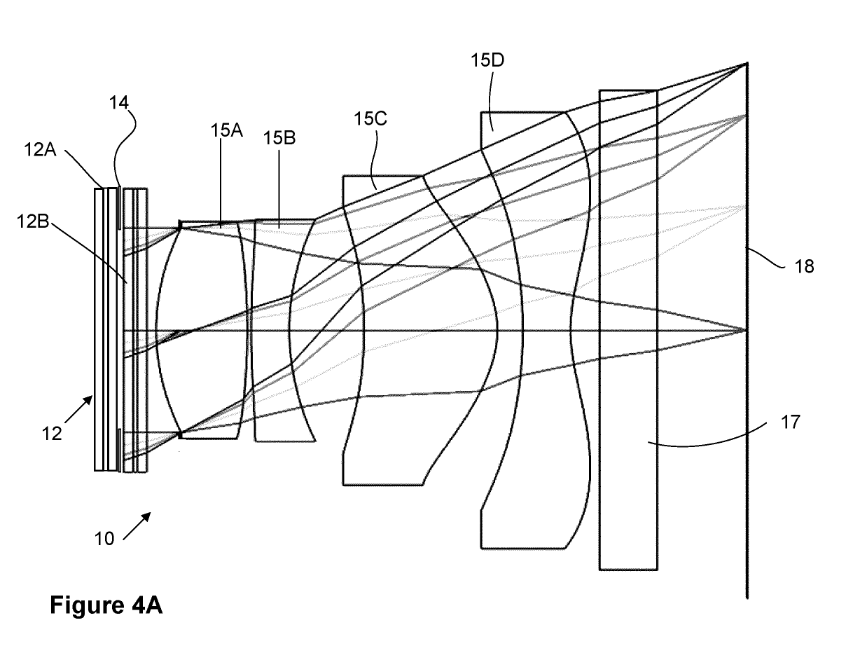

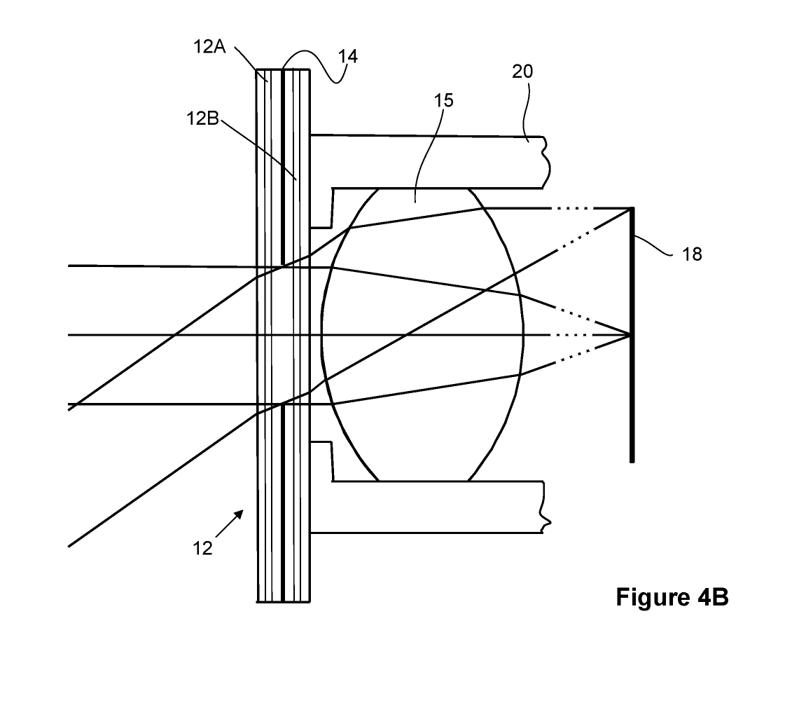

In accordance with an embodiment of the proposed solution schematically illustrated in FIGS. 4A and 4B, the aperture stop 14 from the rim of the external lens 15A (see FIG. 2) is (moved) positioned between two liquid crystal cells 12A and 12B of the TLCL 12. FIG. 4B has a simplified illustration of the base lens 15 (including elements 15A to 15D and perhaps 17), showing (representative) rays crossing at the aperture stop 14 within the TLCL 12 and being imaged onto image plane 18. This allows the portion of the TLCL being used to accept light entering the camera to be of smaller aperture for the same size of lens assembly. This geometry places the stop 14 at about 160 microns from each TLCL cell, which is much less than the about 570 microns in the arrangement of FIG. 2. In the proposed configuration the clear aperture of tunable lens 12 can be 1.32 mm, whereas in the original configuration of FIGS. 1 and 2, the clear aperture of lens 12 was 2.2 mm.

The exact position of the aperture stop 14 can vary without limiting the invention thereto. For example:

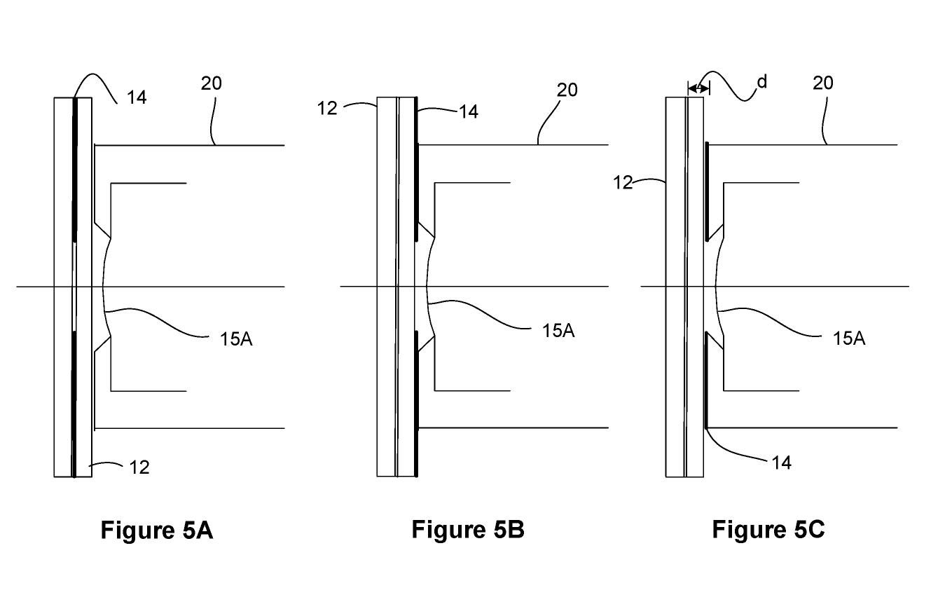

In accordance with another embodiment of the proposed solution schematically illustrated in FIG. 5A, there is shown a (lens) barrel 20 adapted to have a TLCL 12 mounted to its end with the stop 14 contained in the TLCL as illustrated in FIGS. 4A and 4B. In FIGS. 5A to 5C, there is shown a gap between the TLCL 12 and the end of the barrel 20, however, this is only for (clearer) illustration purposes, and the TLCL 12 would be mounted in contact with (abutting) the object end of the barrel 20. The (convex) lens 15A can have an apex on the optical axis almost in contact with the TLCL.

In a further embodiment of the proposed solution schematically illustrated in FIG. 5B, the aperture stop 14 can be provided (mounted/placed/manufactured) on the TLCL 12 on its external surface that is next to the barrel 20. For example, the aperture stop 14 can include a coating deposited or formed during wafer level manufacturing.

In accordance with another embodiment of the proposed solution schematically illustrated in FIG. 5C, the aperture stop 14 is on the external end of the frame or barrel 20 (abutting the TLCL 12).

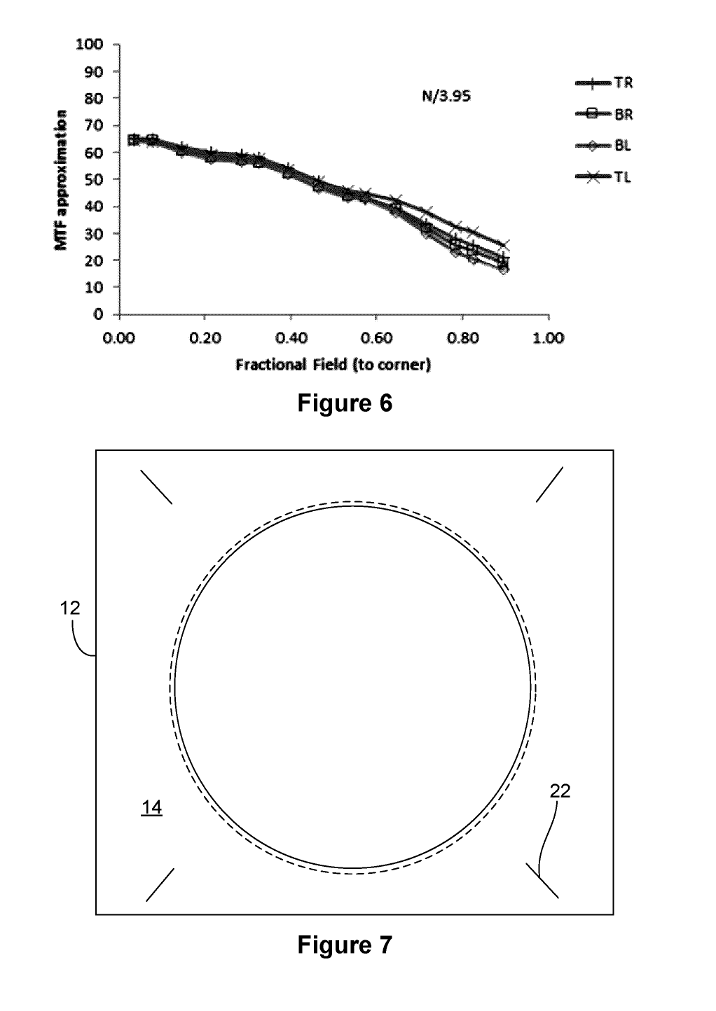

In the embodiment of FIG. 5A, where the aperture stop 14 is located into the TLCL 12, the MTF improves significantly over the configuration illustrated in FIG. 2, as illustrated in FIG. 6. For example, the MTF was around 60 at low fractional field and then dropped below 30 as of 0.50 to 0.65 fractional field (depending of the direction) in the configuration in which the aperture stop 14 placed at the rim of lens 15A (FIG. 2), while locating the aperture stop 14 within the TLCL 12 (FIG. 5A) results in the MTF being around 65 at low fractional field and then being more consistent for all directions out to a 0.60 fractional field and maintaining an MTF at or above 30 until a fractional field of at least 0.70.

Minimizing the clear aperture (14) of the LC tunable lens 12 can provide: reduced aberrations, sharper image, higher tunable optical power, faster response time, and possibly reduced light scattering. A smaller clear aperture can also permit reducing the LC thickness. In accordance with a variant (not-shown) of the embodiment of the proposed solution illustrated in FIG. 5B, employing a TLCL 12 of reduced thickness may permit placement of the aperture stop 14 on the external surface of the TLCL 12 outside the lens assembly.

FIG. 7 schematically illustrates an electrically tunable lens, such as a TLCL 12, having an aperture stop 14 provided within its layered geometry for example as illustrated in FIG. 5A or provided on an external surface thereof as illustrated in FIG. 5B. The aperture stop 14 can include an opaque mask inset within a limit of a clear aperture of the TLCL 12, for example the clear aperture of the TLCL 12 can be defined by electrodes or an electrode structure of the TLCL 12.

The opaque mask can include alignment marks 22, for example in corners of the device 12 to allow for alignment of the optical axis of the TLCL 12 with the optical axis of the lens assembly (10) that can be defined by the barrel 20. Such marks can be used in manufacturing to provide a way to align the aperture stop 14 with the barrel 20, when the aperture stop (14) itself is not visible during assembly. The marks 22 can be provided on the same surface as the aperture stop 14 (FIG. 5B). For example, the opaque mask can include: a metallic layer mask or a light absorbing material mask. In accordance with another variant the marks 22 can be provided on a different external surface of the TLCL 12 (not shown).

Alignment of a TLCL 12 with a lens assembly can be simplified in some cases by using dynamic control over optical properties of the lens 12 to compensate for misalignment between the lens 12 and the barrel 20 or for variances in the optical properties of the lens assembly. Some TLCL's can have their optical axis variably controlled using segmented electrodes. In the configuration in which a TLCL has an integrated aperture stop 14, alignment between the aperture stop 14 and the barrel 20 can be provided with precision at the time of (during) manufacturing.

While the invention has been illustrated and described with reference to preferred embodiments thereof, it will be recognized by those skilled in the art that various changes in form and detail may be made therein without departing from the spirit and scope of the invention as defined by the appended claims.

1. An autofocus camera assembly comprising:
an electrically controllable optical power lens;
a lens assembly having a frame supporting at least one lens element near said electrically controllable optical power lens, said electrically controllable optical power lens being mounted to an object end of said frame; and
an aperture stop located either at or within said electrically controllable optical power lens or located on an external surface of said frame next to said electrically controllable optical power lens.

2. The assembly as defined in claim 1, wherein said electrically controllable optical power lens is a tunable liquid crystal lens (TLCL) comprising at least two liquid crystal cells each configured to modulate a focus of one linear polarization of light, said TLCL having a tunable range of optical power suitable to adjust a focus of a camera from far field to near field.

3. The assembly as defined in claim 1, wherein the aperture stop comprises an opaque mask.

4. The assembly as defined in claim 1, wherein the aperture stop is provided as a coating on a substrate of one of said liquid crystal cells.

5. The assembly as defined in claim 4, wherein said coating is provided between two of said at least two liquid crystal cells.

6. The assembly as defined in claim 4, wherein said coating is provided on an outer surface of said tunable liquid crystal lens.

7. The assembly as defined in claim 1, further comprising alignment marks registered with respect to said aperture stop.

8. The assembly as defined in claim 3, wherein said opaque mask further comprises alignment marks registered with respect to said aperture stop.

9. The assembly as defined in claim 1, wherein said frame comprises a flat mounting surface at said object end of said frame, and said electrically controllable optical power lens has a flat layered construction and is abutted against said flat mounting surface.

10. The assembly as defined in claim 1, wherein said at least one lens element comprises a plurality of lens elements.

11. A tunable liquid crystal lens comprising at least two liquid crystal cells each modulating a focus of one linear polarization of light and an aperture stop opaque mask inset within a limit of a clear aperture defined by electrodes of said cells.

12. The lens as defined in claim 11, wherein the aperture stop opaque mask is located between said cells.

13. The lens as defined in claim 11, wherein the aperture stop opaque mask is located on an external surface of said cells.

14. The lens as defined in claim 11, wherein the aperture stop is provided as a coating on a substrate of one of said liquid crystal cells.

15. The lens as defined in claim 11, further comprising alignment marks registered with respect to said aperture stop.

16. The lens as defined in claim 15, wherein the alignment marks are provided as a coating on a substrate of one of said liquid crystal cells.
